(19) United States
(12) Patent Application Publication
(10) Pub. No.: US 2026/0091443 A1
(43) Pub. Date: Apr. 2, 2026

(54) PLASMA GENERATOR

(71) Applicant: DAIHEN CORPORATION, OSAKA (JP)

(72) Inventors: Hayato NOTOMI, Osaka (JP); Shigeki AMADATSU, Osaka (JP)

(21) Appl. No.: 19/339,941

(22) Filed: Sep. 25, 2025

(30) Foreign Application Priority Data
Sep. 27, 2024 (JP) 2024-169177

(51) Int. Cl. B23K 10/02; H05H 1/34

(52) U.S. Cl. CPC B23K 10/02; H05H 1/3447

(57) ABSTRACT

A discharge may occur in a location in the circumferential direction of a tip portion of an electrode rod, and such a discharge may cause localized consumption of the electrode rod. A plasma generator includes: a nozzle made of metal, the nozzle including a gas passage through which a process gas flows, and an emission port from which the process gas is emitted through the gas passage; and an electrode rod inserted into the gas passage, a voltage being applied between the nozzle and the electrode rod. The plasma generator includes a rotation mechanism that rotates the nozzle about an axis of the electrode rod as a rotating axis. An inner wall surface of the gas passage includes a projection that projects toward the tip portion of the electrode rod.

### RELATED APPLICATIONS

This application claims priority to Japanese Patent application No. JP2024-169177, filed on September 27, 2024, the entire content of which is incorporated herein by reference.

### BACKGROUND OF THE INVENTION

### Field of the Invention

The present invention relates to a plasma generator.

### Description of the Related Art

This type of technique is disclosed, for example, in JP H06-54471 U, which is a plasma generator (plasma torch) provided with a nozzle having a gas passage, and an electrode rod disposed inside of the gas passage. When generating a plasma, a discharge is created between the electrode rod and the nozzle by applying a voltage therebetween, and a process gas is partially converted into a plasma (activated). In this plasma generator, a columnar insulating guide having helical grooves formed thereon is mounted to the electrode rod, whereby a swirling flow is generated in the process gas flowing toward a tip portion of the electrode rod. This forms a thin coolant gas layer on an inner peripheral surface of the nozzle, and a temperature increase in the inner wall of the nozzle is suppressed.

### SUMMARY OF THE INVENTION

In the plasma generator described in JP H06-54471 U, however, the swirling flow of the process gas reaching the tip portion of the electrode rod may not be sufficient, and a discharge may occur in a specific location in the circumferential direction of the tip portion of the electrode rod. Such a discharge may cause localized consumption of the electrode rod.

The present invention has been made in view of the foregoing, and provides a plasma generator capable of suppressing localized consumption of the electrode rod. In view of the above-described issue, a plasma generator according to the present invention includes: a nozzle made of metal, the nozzle including a gas passage through which a process gas flows, and an emission port from which the process gas containing a plasma is emitted through the gas passage; and an electrode rod inserted into the gas passage, wherein a voltage for plasma generation is applied between the nozzle and the electrode rod. The plasma generator includes a rotation mechanism that rotates the nozzle about an axis of the electrode rod as a rotating axis. An inner wall surface of the gas passage includes a projection that projects toward a tip portion of the electrode rod.

According to the present invention, a discharge occurs when a voltage is applied between the projection formed on the inner wall surface of the nozzle and the tip portion of the electrode rod, and the process gas flowing therebetween can be partially converted into a plasma. Herein, since the nozzle is rotated about the axis of the electrode rod by the rotation mechanism, the projection formed on the inner wall surface of the gas passage also revolves around the tip portion of the electrode rod. This can prevent a discharge from occurring in a specific location in the circumferential direction of the tip portion of the electrode rod, and can suppress localized consumption of the electrode rod by this discharge.

In a preferred aspect, the gas passage includes a throttle space having a passage cross section that gradually reduces toward the emission port. The throttle space includes a base end portion located upstream of the process gas along a direction of the axis and a distal end portion located downstream of the process gas. The projection is formed in a position adjacent to at least the base end portion.

According to this aspect, since the projection is formed in the position adjacent to the base end portion of the throttle space, the end portion of the projection can have a larger radius of motion along with the rotation of the nozzle about the axis as compared to the projection provided in a position adjacent to the distal end portion of the throttle space. Consequently, a discharge can be created in a wider area of the surface of the tip portion of the electrode rod.

In another preferred aspect, the projection is continuously formed from the base end portion of the throttle space to the distal end portion. A height from an inner wall surface forming the throttle space gradually reduces from the base end portion of the throttle space toward the distal end portion.

According to this aspect, a discharge occurs at the end of the projection on the side closer to the base end portion of the throttle space, the process gas is partially converted into a plasma, and a plasma can be generated. Herein, the projection extending from the base end portion of the throttle space to the distal end portion acts as a vane for swirling the process gas (the plasma-containing process gas) in the throttle space. This allows the plasma-containing process gas passing through the throttle space to swirl. Consequently, the emitted plasma can be fed farther from the end of the nozzle.

In a further preferred aspect, the throttle space is a space having a shape of a truncated cone. On the inner wall surface forming the throttle space, the projection is inclined with respect to a generatrix of the truncated cone such that a swirling flow of the process gas is formed in a same direction as a rotating direction of the nozzle.

According to this aspect, on the inner wall surface forming the throttle space, the projection is inclined with respect to the generatrix of the truncated cone such that the plasma-containing process gas swirls in the same direction as the rotating direction of the nozzle, and thus it is possible to increase the swirling property of the plasma-containing process gas in the throttle space. Consequently, the emitted plasma can be fed even farther from the end of the nozzle.

An end portion of the projection facing the tip portion of the electrode rod includes a chamfered surface.

When the end of the projection formed on the inner wall surface of the nozzle is pointed, a discharge tends to occur in a specific position of the tip portion of the electrode rod. However, according to this aspect including the chamfered surface formed on the end of the projection, it is possible to eliminate a pointed end and suppress localized discharges in the end portion of the projection.

According to the present invention, it is possible to suppress localized consumption of the electrode rod.

### BRIEF DESCRIPTION OF THE DRAWINGS

FIG. 1 is an exploded perspective view of a plasma generator according to an embodiment of the present invention, with a cover removed.

FIG. 2A is a perspective view of a nozzle tip illustrated in FIG. 1 when viewed from the lower side.

FIG. 2B is a perspective view of the nozzle tip when viewed from the upper side.

FIG. 2C is a top view of the nozzle tip.

FIG. 2D is a cross-sectional view of the nozzle tip.

FIG. 3 is a cross-sectional view of a main part of the plasma generator of FIG. 1.

FIG. 4A is a cross-sectional view of a modification example of the nozzle of the plasma generator.

FIG. 4B is a cross-sectional view of another modification example of the nozzle of the plasma generator.

### DETAILED DESCRIPTION OF THE PREFERRED EMBODIMENTS

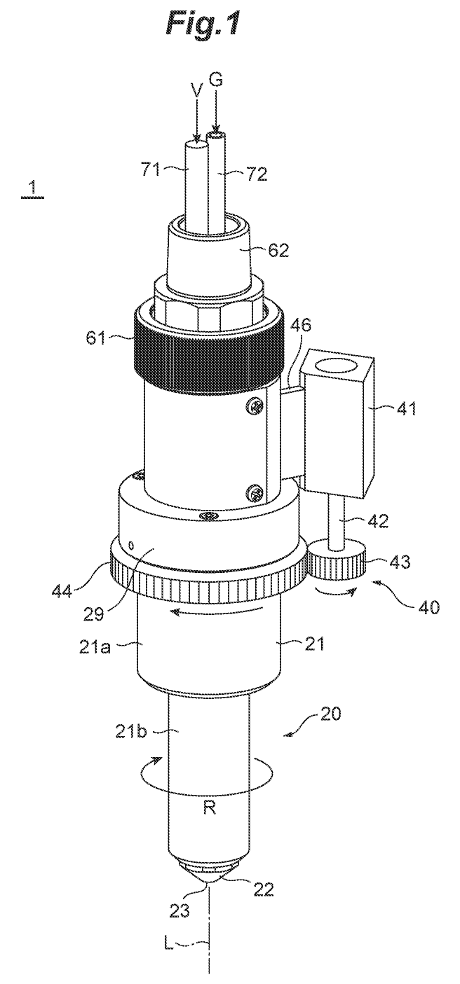

Hereinafter, a plasma generator 1 according to an embodiment of the present invention will be described with reference to FIG. 1 to FIG. 4B. The plasma generator 1 applies a voltage V for plasma generation between a nozzle 20 supplied with a process gas and an electrode rod 11 inserted into the nozzle 20 so as to create a discharge between the electrode rod 11 and the nozzle 20, and generates a plasma from a part of the supplied process gas. Then, the plasma generator 1 emits the generated plasma from an emission port 23.

Examples of the discharge between the electrode rod 11 and the nozzle 20 may include an arc discharge, a streamer discharge, or a glow discharge, and the form of the discharge is not particularly limited as long as a plasma can be generated. The type of discharge can be set depending on the type of process gas and conditions of voltage applied (the magnitude of voltage and the shape of waveform of the voltage, etc.). It is noted that in this specification, the plasma-containing process gas may be hereinafter referred to as plasma since the process gas partially becomes a plasma.

In the above-described plasma generator 1, the process gas (for example, O₂, etc.) flowing from the upstream side is partially ionized, and a plasma is generated. The plasma generator 1 sprays the process gas containing the generated plasma and performs a predetermined process using the sprayed plasma. For example, the plasma generator 1 performs surface modification on a metal member or the like with the plasma. It is needless to mention that the plasma generator 1 may be used in other applications.

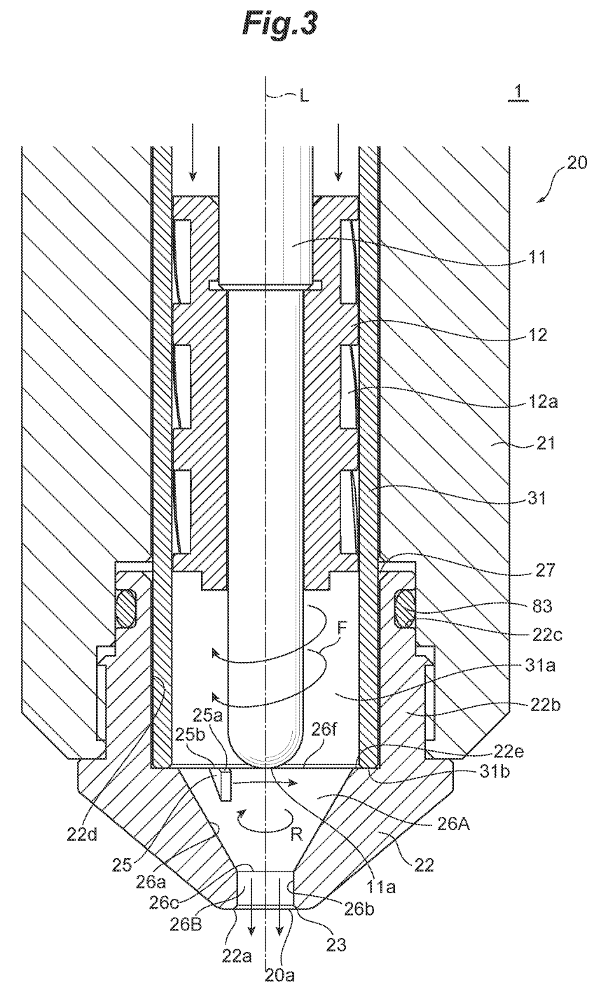

As illustrated in FIG. 3, the electrode rod 11 is a rod-shaped member made of metal including copper as a main material, for example. The electrode rod 11 is inserted into a gas passage 26 of the nozzle 20 (described later) in a non-contact state with the nozzle 20, and the voltage V is applied between the electrode rod 11 and the nozzle 20. The electrode rod 11 includes a tip portion 11a, which may have a cone shape or a truncated cone shape. In the present embodiment, the tip portion 11a has a hemisphere surface. With such a configuration, the tip portion 11a of the electrode rod 11 has a rounded surface, and this allows suppressing a discharge from a specific position of the tip portion 11a of the electrode rod 11.

The base end of the electrode rod 11 is attached to an electrode holder (not illustrated) or the like made of metal such as copper, and an electric wire 71 illustrated in FIG. 1 is attached to the electrode holder. This allows the electrode rod 11 to be supplied with a voltage V (specifically, a voltage of a pulse waveform) from a power supply (not illustrated) connected to the electric wire 71.

Furthermore, a columnar rectifying member 12 having a plurality of helical grooves 12a formed on its outer circumferential surface is attached to the electrode rod 11. The rectifying member 12 is a member for directing the process gas linearly traveling along the gas passage 26 so as to form a swirling flow of the process gas, and is placed in an inner space 31a of a tubular body 31 (described later). With the grooves 12a formed on the outer circumferential surface of the rectifying member 12, the process gas having passed through the grooves 12a forms a swirling flow F downstream of the rectifying member 12. The grooves 12a are formed such that the direction of the swirling flow of the process gas having passed through the rectifying member 12 is equal to the rotating direction R of the nozzle 20 (described later).

As illustrated in FIG. 3, the plasma generator 1 includes at least the nozzle 20 made of metal and the electrode rod 11. The nozzle 20 includes the gas passage 26 through which the process gas flows and the emission port 23 from which the plasma-containing process gas is emitted through the gas passage 26. The nozzle 20 is connected to ground, and includes a tubular nozzle body 21, and a nozzle tip 22 screwed into an end portion of the nozzle body 21. Though not illustrated, the upstream structure of the gas passage 26 is connected to a gas supply tube 72.

In the present embodiment, the nozzle body 21 is a tubular body including a large-diameter portion 21a and a small-diameter portion 21b. A ring gear 44 is attached to the large-diameter portion 21a. The nozzle tip 22 is attached to the distal end of the small-diameter portion 21b such that the gas passage 26 is formed along an axis L of the electrode rod 11 inserted. In the present embodiment, the nozzle 20 is made up of the nozzle body 21 and the nozzle tip 22, but the nozzle body 21 and the nozzle tip 22 may be integrally formed as long as the electrode rod 11 and the tubular body 31 (described later) and the like can be inserted into the nozzle 20.

In the present embodiment, the tubular body 31 made of an insulating material, such as ceramic (e.g., alumina), is placed in the gas passage 26 so as to cover the electrode rod 11 along the axis L of the electrode rod 11. The inner space 31a of the tubular body 31 forms part of the gas passage 26 of the nozzle 20.

As illustrated in FIG. 1, the plasma generator 1 includes a rotation mechanism 40 that rotates the nozzle 20 about the axis L of the electrode rod 11 as a rotating axis. The rotation mechanism 40 includes a motor 41 and a pinion gear 43 that is attached to an output shaft 42 of the motor 41. The pinion gear 43 meshes with the ring gear 44 that is securely attached to the nozzle body 21. A casing 29 is fixed to external equipment (not illustrated) and also to the electrode rod 11 via an internal component and the like (not illustrated). The internal component and the electrode rod 11 are rotatable via a bearing. Accordingly, when the motor 41 is driven, the nozzle 20 can be rotated relative to the electrode rod 11 about the axis L of the electrode rod 11 as a rotating axis.

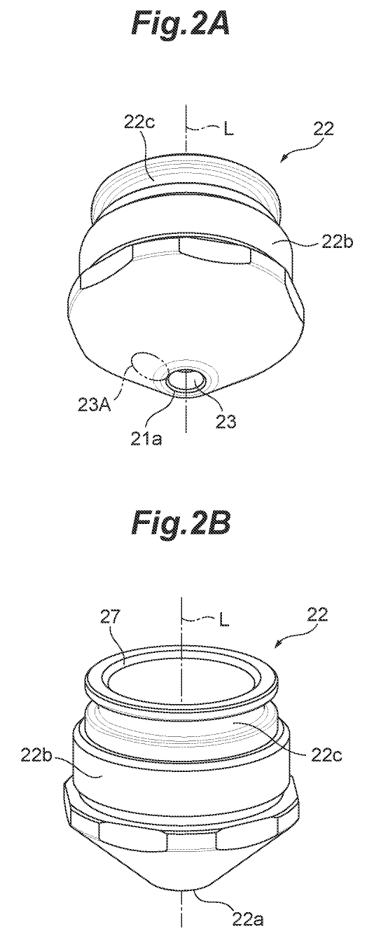

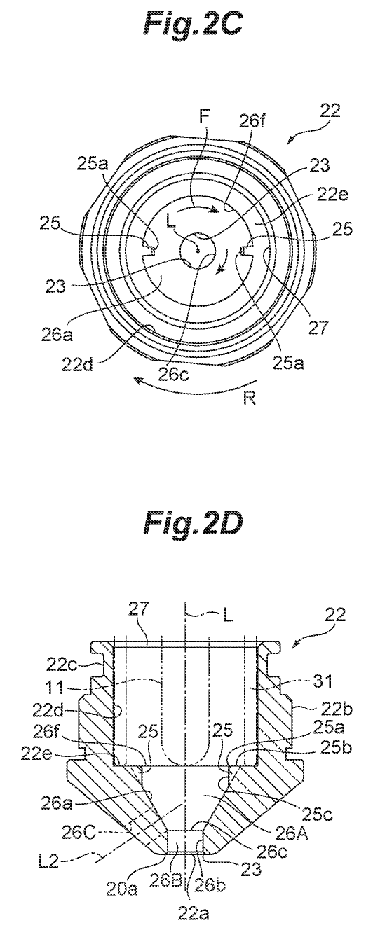

As illustrated in FIG. 2A and FIG. 2B, the nozzle tip 22 includes a thread groove (not illustrated) formed on an outer surface 22b and a seal groove 22c. As illustrated in FIG. 3, an O-ring 83 is arranged in the seal groove 22c, and the nozzle tip 22 is screwed into the nozzle body 21 by screwing the thread groove of the nozzle tip 22 into the nozzle body 21. The nozzle tip 22 includes an opening 27 through which an end of the tubular body 31 made of an insulating material is inserted. Until an end face 31b of the tubular body 31 contacts a ring-shaped bottom surface 22e of the nozzle tip 22, the tubular body 31 is inserted through the opening 27 along an inner peripheral surface 22d continuing from the opening 27 (see FIG. 2D). The nozzle tip 22 includes the emission port 23 from which the plasma-containing process gas is emitted at a position corresponding to an end 22a of the nozzle tip 22 (an end 20a of the nozzle 20).

As illustrated in FIG. 2C and FIG. 2D, the gas passage 26 of the nozzle tip 22 includes a throttle space 26A having a passage cross section that gradually reduces toward the emission port 23. The throttle space 26A is a space having a shape of a truncated cone. The throttle space 26A includes a base end portion 26f located upstream of the process gas along the direction of the axis L of the electrode rod 11 and a distal end portion 26c located downstream of the process gas. Between the distal end portion 26c of the throttle space 26A and the emission port 23, a cylindrical communicating space 26B that connects the throttle space 26A and the emission port 23 is formed along the axis L of the electrode rod 11. The communicating space 26B is a cylindrical space formed by an inner wall surface 26b.

The inner wall surface 26b forming the communicating space 26B may include a helical recessed groove formed such that a swirling flow F is formed in the same direction as the swirling flow F of the process gas formed by the rectifying member 12. With this configuration, the plasma-containing process gas (the gas converted into a plasma) can be emitted from the emission port 23 while forming the swirling flow F in the rotating direction of the nozzle 20, and the emitted plasma can be fed farther from the end of the nozzle.

It is noted that in the present embodiment, the communicating space 26B is formed in the direction along the axis L of the electrode rod 11, but as illustrated in FIG. 2D, for example, a communicating space 26C may be formed along a virtual line L2 crossing the axis L. In this case, an emission port 23A is formed in the position illustrated in FIG. 2A, and thus the process gas emitted from the emission port 23A can be sprayed in a wider area when the nozzle 20 is rotated about the axis L.

In the present embodiment, an inner wall surface 26a of the throttle space 26A of the gas passage 26 includes a projection 25 that projects toward the tip portion 11a of the electrode rod 11. The projection 25 is formed in a position adjacent to the base end portion 26f. As illustrated in FIG. 2D, the projection 25 includes an upper end surface 25b extending toward the axis L and a side surface 25c parallel to the axis L. Then, the height of the projection 25 from the inner wall surface 26a forming the throttle space 26A gradually reduces from the base end portion 26f of the throttle space 26A toward the distal end portion 26c. A boundary portion between the upper end surface 25b and the side surface 25c forms an end portion facing the tip portion 11a of the electrode rod 11, and this end portion includes a chamfered surface 25a.

According to the present embodiment, a discharge occurs when a voltage is applied between the projection 25 formed on the inner wall surface 26a of the nozzle 20 and the tip portion 11a of the electrode rod 11, and the process gas flowing therebetween can be partially converted into a plasma.

Herein, since the nozzle 20 is rotated about the axis L of the electrode rod 11 by the rotation mechanism 40, the projection 25 formed on the inner wall surface 26a of the gas passage 26 also revolves around the tip portion 11a of the electrode rod 11. This can prevent a discharge from occurring in a specific location in the circumferential direction of the tip portion 11a of the electrode rod 11, and can suppress localized consumption of the electrode rod 11 by this discharge. It is noted that with such a discharge, the process gas partially becomes a plasma, and the plasma-containing process gas can be emitted from the emission port 23.

Furthermore, since the projection 25 is formed in a position adjacent to the base end portion 26f of the throttle space 26A, the end of the projection 25 (in the present embodiment, the chamfered surface 25a) can have a larger radius of motion along with the rotation of the nozzle 20 about the axis as compared to the projection 25 provided in a position adjacent to the distal end portion 26c of the throttle space 26A. Consequently, a discharge can be created in a wider area of the surface of the tip portion 11a of the electrode rod 11.

Furthermore, when the end of the projection 25 formed on the inner wall surface 26a of the nozzle 20 is pointed, a discharge tends to occur in a specific position of the tip portion 11a of the electrode rod 11. With the chamfered surface 25a formed on the end of the projection 25, it is possible to eliminate a pointed end and suppress localized discharges in the end portion of the projection 25.

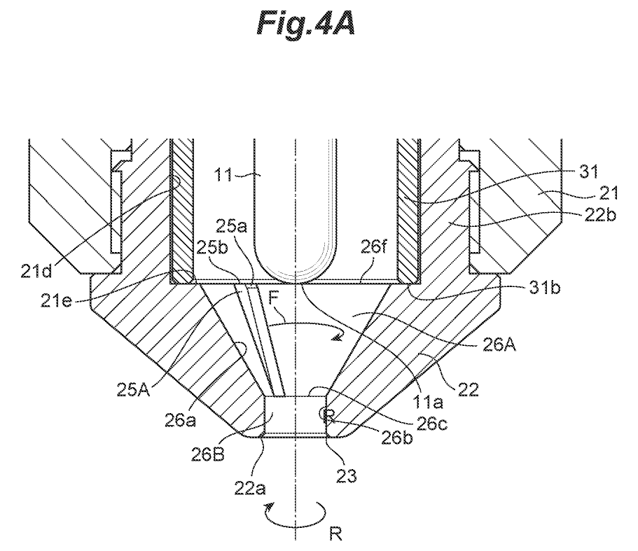

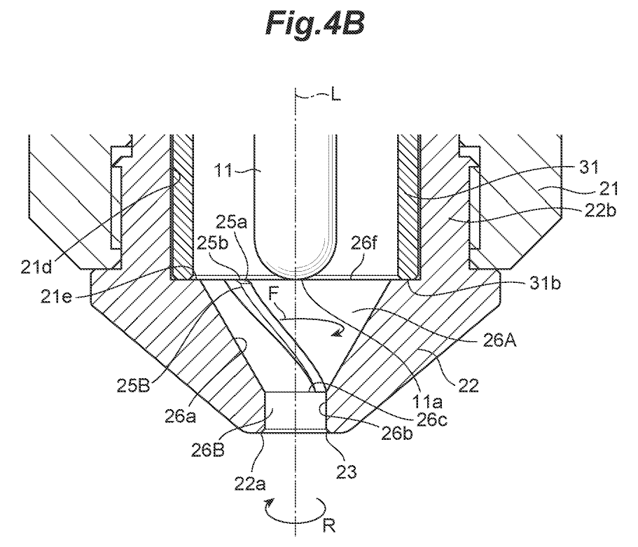

FIG. 4A is a cross-sectional view of a modification example of the nozzle of the plasma generator. As illustrated in the modification example of this FIG. 4A, a projection 25A may be continuously formed from the base end portion 26f of the throttle space 26A to the distal end portion 26c. The height of the projection 25 from the inner wall surface 26a forming the throttle space 26A gradually reduces from the base end portion 26f of the throttle space 26A toward the distal end portion 26c.

According to this modification example, a discharge occurs at the end (the chamfered surface 25a) of the projection 25A on the side closer to the base end portion 26f of the throttle space 26A, and a plasma is generated. Further, the projection 25A extending from the base end portion 26f of the throttle space 26A to the distal end portion 26c acts as a vane for swirling the process gas (the plasma-containing process gas) in the throttle space 26A. This allows the process gas (the plasma-containing process gas) to swirl in the throttle space 26A. Consequently, the emitted plasma can be fed farther from the end of the nozzle.

FIG. 4B is a cross-sectional view of another modification example of the nozzle of the plasma generator. As illustrated in this FIG. 4B, a projection 25B may be inclined with respect to the generatrix of the truncated cone such that a plasma easily swirls in the same direction as the rotating direction R of the nozzle 20. That is, in this example, the projection 25B is formed in a helical shape so that the process gas (the plasma-containing process gas) can more easily swirl. This can increase the swirling property of the plasma-containing process gas in the throttle space 26A. Consequently, the emitted plasma can be fed even farther from the end 20a of the nozzle 20.

Although the embodiment of the present invention has been described in detail above, the present invention is not limited thereto, and various design changes can be made within the spirit and scope of the present invention recited in the claims.

What is claimed is:

1. A plasma generator, comprising:
a nozzle made of metal, the nozzle including a gas passage through which a process gas flows, and an emission port from which the process gas containing a plasma is emitted through the gas passage; and
an electrode rod inserted into the gas passage, wherein a voltage for plasma generation is applied between the nozzle and the electrode rod,
wherein the plasma generator includes a rotation mechanism that rotates the nozzle about an axis of the electrode rod as a rotating axis, and
wherein an inner wall surface of the gas passage includes a projection that projects toward a tip portion of the electrode rod.

2. The plasma generator according to claim 1,
wherein the gas passage includes a throttle space having a passage cross section that gradually reduces toward the emission port,
wherein the throttle space includes a base end portion located upstream of the process gas along a direction of the axis and a distal end portion located downstream of the process gas, and
wherein the projection is formed in a position adjacent to at least the base end portion.

3. The plasma generator according to claim 2,
wherein the projection is continuously formed from the base end portion of the throttle space to the distal end portion, and
wherein a height from an inner wall surface forming the throttle space gradually reduces from the base end portion of the throttle space toward the distal end portion.

4. The plasma generator according to claim 3,
wherein the throttle space is a space having a shape of a truncated cone, and
wherein on the inner wall surface forming the throttle space, the projection is inclined with respect to a generatrix of the truncated cone such that a swirling flow of the process gas is formed in a same direction as a rotating direction of the nozzle.

5. The plasma generator according to claim 1, wherein an end portion of the projection facing the tip portion of the electrode rod includes a chamfered surface.
